(19) United States
(12) Patent Application Publication
(10) Pub. No.: US 2025/0303726 A1
(43) Pub. Date: Oct. 2, 2025

(54) LIQUID CONTAINER

(71) Applicant: SEIKO EPSON CORPORATION, Tokyo (JP)

(72) Inventor: Koji KUDO, Shiojiri-shi (JP)

(73) Assignee: SEIKO EPSON CORPORATION, Tokyo (JP)

(21) Appl. No.: 19/092,583

(22) Filed: Mar. 27, 2025

(30) Foreign Application Priority Data
Mar. 28, 2024 (JP) 2024-053535

(51) Int. Cl. B41J 2/175

(52) U.S. Cl. CPC B41J 2/17523; B41J 2/17513; B41J 2/17526; B41J 2/17553; B41J 2002/17516

(57) ABSTRACT

A liquid container includes a liquid containing bag including a bag main body for containing a liquid and a supply member that is attached to one end portion side of the bag main body and that includes a liquid supply portion, an adapter disposed on the one end portion side of the bag main body, and a screw member that fixes the supply member and the adapter.

The present application is based on, and claims priority from JP Application Serial Number 2024-053535, filed Mar. 28, 2024, the disclosure of which is hereby incorporated by reference herein in its entirety.

### BACKGROUND

### 1. Technical Field

The present disclosure relates to a technique for a liquid container.

### 2. Related Art

In the related art, a liquid container that includes a liquid containing portion, a supply path member, and an adapter and in which the supply path member and the adapter are attached to each other by snap-fitting is known (JP-A-2023-13094).

In the related art, in a case where members are attached to each other by snap-fitting, the rigidity of portions constituting the snap fit tends to be lower than that of other portions. Therefore, when members are attached to each other by snap-fitting, the following problems may occur. For example, there is a possibility that the attachment by the snap-fitting between the members is unintentionally released, the portions constituting the snap fit or other portions are damaged, or a positional deviation between the members occurs. In addition, for example, in a case where a positional deviation between the supply path member and the adapter occurs, there is a concern that a connection failure between the supply path member and a printer occurs, and a liquid leaks to the outside. Such a problem is not limited to a liquid container that supplies a liquid to a printer, but is common to a liquid container that supplies a liquid to a liquid ejecting apparatus.

### SUMMARY

According to an aspect of the present disclosure, there is provided a liquid container that supplies a liquid to a liquid ejecting apparatus. The liquid container includes a liquid containing bag including a bag main body for containing the liquid and a supply member that is attached to one end portion side of the bag main body and that includes a liquid supply portion, an adapter disposed on the one end portion side of the bag main body, and a screw member that fixes the supply member and the adapter.

### BRIEF DESCRIPTION OF THE DRAWINGS

FIG. 1 is a schematic perspective view of a liquid ejecting apparatus.

FIG. 2 is a schematic perspective view of a connection mechanism.

FIG. 3 is a first perspective view of a liquid container.

FIG. 4 is a second perspective view of the liquid container.

FIG. 5 is a front view of the liquid container.

FIG. 6 is an exploded perspective view of the liquid container.

FIG. 7 is a schematic view for explaining a supply member.

FIG. 8 is an illustration for explaining a snap-fitting mechanism.

FIG. 9 is an illustration of an adapter viewed from a third surface side.

FIG. 10 is a partial sectional view taken along line X-X in FIG. 5.

FIG. 11 is a sectional view taken along line XI-XI in FIG. 3.

FIG. 12 is an illustration for explaining fixing between an arrangement portion and an adapter main body.

### DESCRIPTION OF EMBODIMENTS

### A. Embodiment

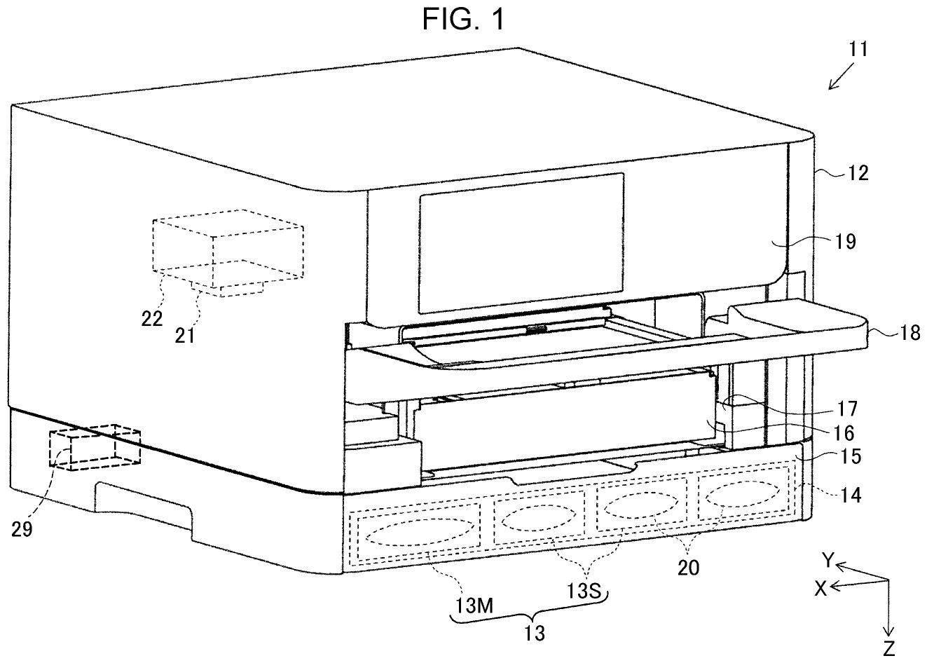

FIG. 1 is a schematic perspective view of a liquid ejecting apparatus 11. The liquid ejecting apparatus 11 is, for example, an ink jet printer that forms a printed image by recording dots by ejecting ink, which is an example of a liquid, onto a medium such as paper.

The liquid ejecting apparatus 11 is provided with a housing 12 which is a substantially rectangular parallelepiped exterior body. A case storage portion 14 in which cases 13 are detachably stored is provided inside the housing 12. In a front surface portion of the housing 12, a front lid 15 that is rotated to open and close the case storage portion 14 and a mounting port 17 in which a cassette 16 capable of storing a medium (not illustrated) is mounted are disposed in order from a bottom portion side to an upper side. Moreover, a discharge tray 18 to which the medium is discharged and an operation panel 19 for a user to operate the liquid ejecting apparatus 11 are disposed above the mounting port 17. The front surface of the housing 12 has a height and a width and refers to a side surface which is assumed to face the user when the user operates the liquid ejecting apparatus 11.

A plurality of cases 13 can be mounted in the case storage portion 14 of the present embodiment so as to be arranged in a width direction. For example, as the plurality of cases 13, three or more cases 13 including a first case 13S and a second case 13M wider than the first case 13S are mounted in the case storage portion 14. A liquid container 20 is removably mounted in each of the cases 13. That is, the liquid container 20 is mounted in the case 13 which is detachably mounted in the liquid ejecting apparatus 11. The case 13 can also be detachably mounted alone in the case storage portion 14 in a state in which the liquid container 20 is not held, and is a constituent element included in the liquid ejecting apparatus 11. The liquid ejecting apparatus 11 is supplied with a liquid from the liquid container 20 by sucking the liquid contained in the liquid container 20 using a pump mechanism (not illustrated).

A liquid ejecting unit 21 that ejects a liquid from nozzles and a carriage 22 that reciprocates in a scanning direction which coincides with the width direction of the liquid ejecting apparatus 11 are provided in the housing 12. The liquid ejecting unit 21 moves together with the carriage 22 and ejects the liquid supplied from the liquid container 20 mounted in the case 13 toward the medium, thereby performing printing on the medium. In another embodiment, the liquid ejecting unit 21 may be a line head that does not reciprocate and whose position is fixed.

In the present embodiment, a direction intersecting with a movement path when the case 13 is mounted into the case storage portion 14 is the width direction, and a direction in which the movement path extends is a depth direction. It is preferable that the movement path and the width direction intersect with each other so as to be orthogonal to each other. The width direction and the depth direction are substantially along a horizontal plane. In the drawings, a direction along gravity in a normal use state in which the liquid ejecting apparatus 11 is placed on a horizontal surface is indicated by a Z-axis, and a moving direction in which the case 13 is mounted into the case storage portion 14 is indicated by a Y-axis. The moving direction may also be referred to as a mounting direction or an insertion direction into the case storage portion 14, and a direction opposite to the moving direction may be referred to as a removing direction. The direction in which the case 13 is mounted into the case storage portion 14 is also a direction in which the liquid container 20 is mounted into the liquid ejecting apparatus 11. The direction in which the case 13 is removed from the case storage portion 14 is also a direction in which the liquid container 20 is removed from the liquid ejecting apparatus 11. The width direction of the liquid ejecting apparatus 11 is indicated by an X-axis orthogonal to the Z-axis and the Y-axis. The width direction, the gravity direction, and the mounting direction intersect with each other and are directions in a case where width, height, and depth are described, respectively. It is preferable that the width direction, the gravity direction, and the mounting direction intersect with each other so as to be orthogonal to each other. In other drawings, an X-axis, a Y-axis, and a Z-axis corresponding to those in FIG. 1 are given.

In the following description, unless otherwise specified, it is assumed that the liquid ejecting apparatus 11 is in the normal use state. In addition, a direction parallel to the Z-axis is referred to as a Z direction, and in the Z direction, the same direction as the gravity direction is also referred to as a +Z direction, and a direction opposite to the gravity direction is referred to as a −Z direction. In addition, a direction parallel to the Y-axis is referred to as a Y direction, and in the Y direction, one direction is referred to as a +Y direction, and the other direction is referred to as a −Y direction. A direction parallel to the X-axis is referred to as an X direction, and in the X direction, one direction is referred to as a +X direction, and the other direction is referred to as a −X direction. The +Y direction is the moving direction of the case 13 in which the case 13 is inserted into the case storage portion 14.

One or a plurality of connection mechanisms 29 is provided at an end portion of the case storage portion 14 on the +Y direction side so as to individually correspond to the cases 13. In the present embodiment, four connection mechanisms 29 are provided. In FIG. 1, only one connection mechanism 29 is illustrated.

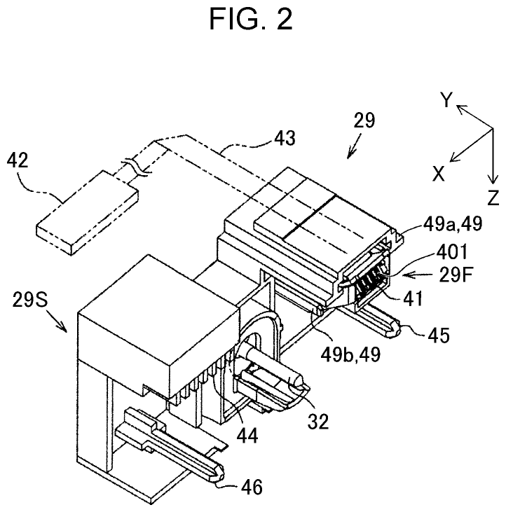

FIG. 2 is a schematic perspective view of the connection mechanism 29. The connection mechanism 29 includes a liquid introduction portion 32 to which the liquid container 20 is connected, and a first connection mechanism 29F and a second connection mechanism 29S at positions between which the liquid introduction portion 32 is interposed in the width direction. The liquid introduction portion 32 has a flow path through which a liquid flows, and the liquid from the liquid container 20 flows through the liquid introduction portion 32. An opening for allowing the liquid to flow through the flow path inside is formed at a leading end of the liquid introduction portion 32 on the −Y direction side. A liquid flow path such as a tube (not illustrated) is connected to a base end portion of the liquid introduction portion 32 on the +Y direction side. The liquid flow path supplies the liquid to the liquid ejecting unit 21.

The first connection mechanism 29F includes an apparatus-side electrical connecting portion 41 and apparatus-side positioning portions 49. The apparatus-side electrical connecting portion 41 is disposed above the liquid introduction portion 32 and protrudes in the −Y direction, which is the removing direction. The apparatus-side electrical connecting portion 41 includes a plurality of apparatus-side electrodes 401. Each of the plurality of apparatus-side electrodes 401 is a metal plate-shaped terminal. In the present embodiment, nine apparatus-side electrodes 401 are provided. The number of the apparatus-side electrodes 401 is not limited to the above-described number and may be less than nine or more than nine. For example, the number of the apparatus-side electrodes 401 may be five or seven. Each apparatus-side electrode 401 is electrically connected to a control device 42 via an electric line 43 such as a flat cable. The apparatus-side positioning portions 49 are located on both sides of the apparatus-side electrical connecting portion 41 in the width direction. Each of the two apparatus-side positioning portions 49 is a protrusion that protrudes in the width direction and extends in the +Y direction, which is the mounting direction. In a case where the two apparatus-side positioning portions 49 are distinguished from each other, a first apparatus-side positioning portion 49a and a second apparatus-side positioning portion 49b are used.

The second connection mechanism 29S includes a block 44 for preventing erroneous insertion, and the block 44 is disposed above the liquid introduction portion 32 and protrudes in the removing direction. The block 44 has protrusions and recesses facing downward. The shape of the protrusions and recesses is different for each connection mechanism 29 disposed in the case storage portion 14.

The connection mechanism 29 further includes a pair of positioning portions 45 and 46. The first positioning portion 45 is included in the first connection mechanism 29F, and the second positioning portion 46 is included in the second connection mechanism 29S. The first positioning portion 45 and the second positioning portion 46 are each configured as a shaft-shaped portion extending toward the −Y direction side and are provided at positions separated from each other in the X direction with the liquid introduction portion 32 interposed therebetween.

The connection mechanism 29 is located at an end portion of the case storage portion 14 on the +Y direction side. Therefore, the liquid introduction portion 32 and the apparatus-side electrical connecting portion 41 included in the connection mechanism 29 are located at the end portion of the case storage portion 14 on the +Y direction side. In addition, the liquid introduction portion 32, the first positioning portion 45, and the second positioning portion 46 extend from the end portion of the case storage portion 14 on the +Y direction side toward the −Y direction side.

As described above, the liquid container 20 is detachably mounted in the liquid ejecting apparatus 11 and supplies the liquid to the liquid ejecting apparatus 11.

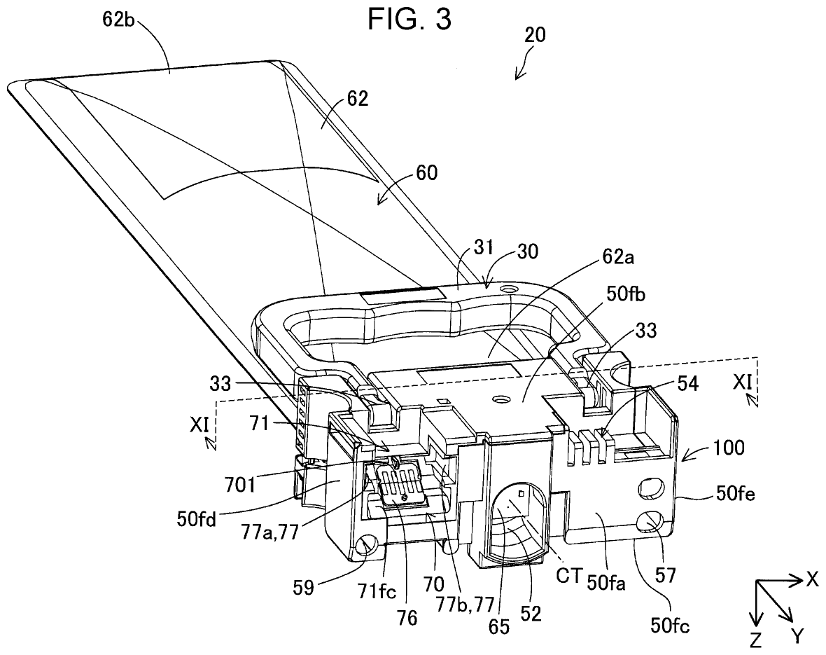

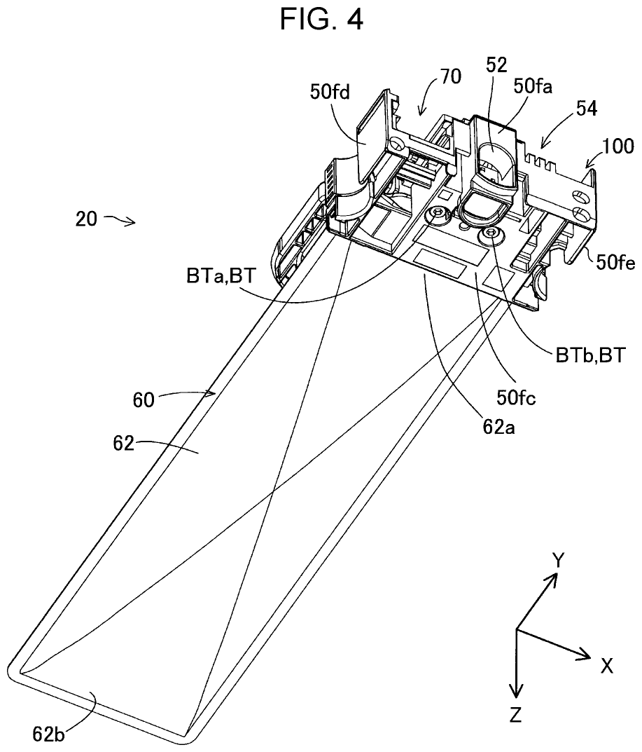

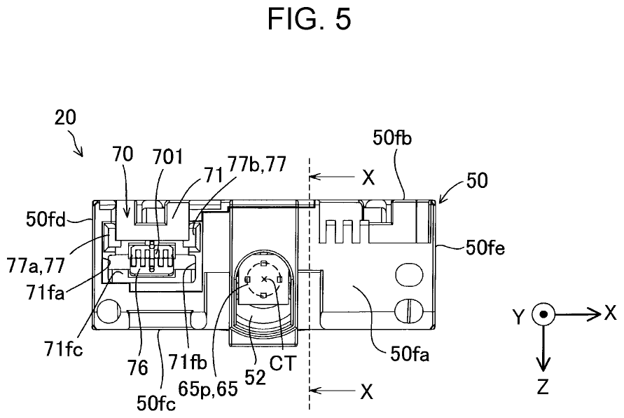

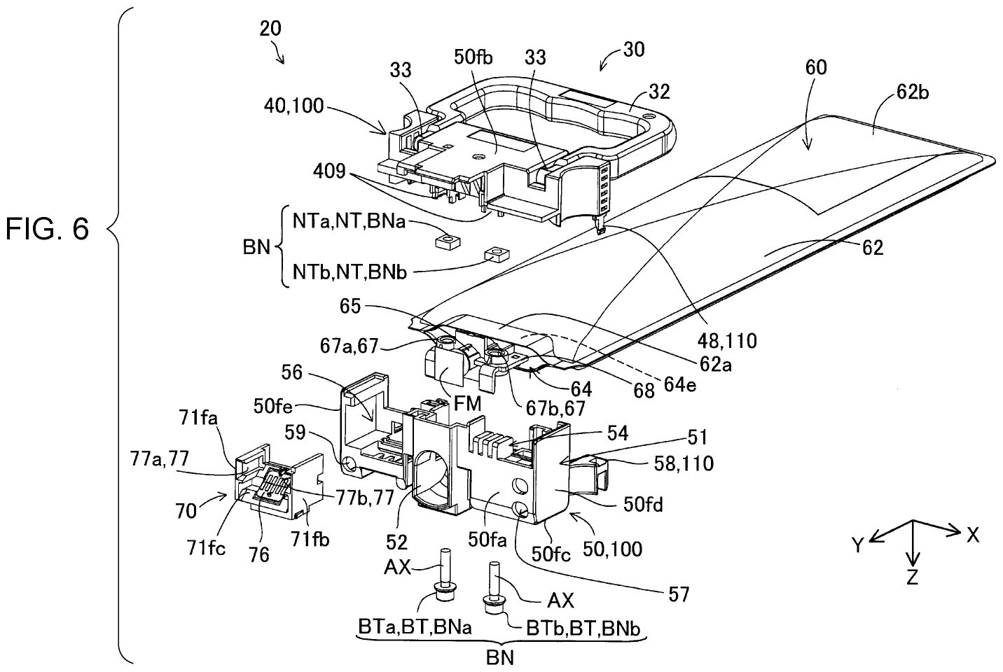

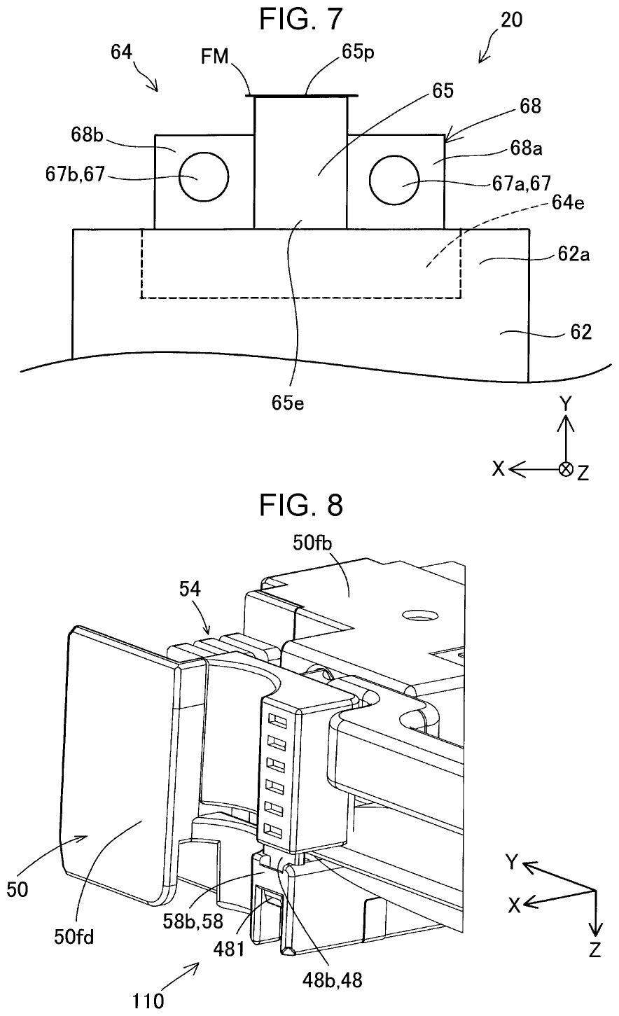

FIG. 3 is a first perspective view of the liquid container 20. FIG. 4 is a second perspective view of the liquid container 20. FIG. 5 is a front view of the liquid container 20. FIG. 6 is an exploded perspective view of the liquid container 20. FIG. 7 is a schematic view for explaining a supply member 64. In FIG. 3 and the subsequent figures for explaining the liquid container 20, the X-axis, the Y-axis, and the Z-axis are given with reference to a state where the liquid container 20 is mounted in the liquid ejecting apparatus 11 in the normal use state of the liquid ejecting apparatus 11.

As illustrated in FIGS. 3 and 4, the liquid container 20 including the supply member 64 includes a liquid containing bag 60, an adapter 100 disposed on the liquid containing bag 60, and screw members BN illustrated in FIG. 6 for fixing the supply member 64 and the adapter 100. In the present embodiment, each screw member BN includes a bolt BT and a nut NT. Two bolts BT and two nuts NT are provided. When the two bolts BT are distinguished from each other, a first bolt BTa and a second bolt BTb are used. When the two nuts NT are distinguished from each other, a first nut NTa and a second nut NTb are used. The first bolt BTa and the first nut NTa constitute a first screw member BNa. The second bolt BTb and the second nut NTb constitute a second screw member BNb. The liquid container 20 has a substantially rectangular parallelepiped shape in which the X direction is a lateral direction, the Y direction is a longitudinal direction, and the Z direction is a thickness direction.

As illustrated in FIG. 6, the adapter 100 includes a first adapter 40 and a second adapter 50. In the present embodiment, in a state where the supply member 64 is interposed between the first adapter 40 and the second adapter 50, the supply member 64 is fixed to the adapter 100 by the screw members BN. That is, the second adapter 50 is located on a side opposite to the first adapter 40 with the supply member 64 interposed therebetween. The second adapter 50 includes an adapter main body 51 and an arrangement portion 70 removably fixed to the adapter main body 51. Details of the manner in which the supply member 64 and the adapter 100 are fixed by the screw members BN including the first screw member BNa and the second screw member BNb will be described later.

As illustrated in FIG. 6, the liquid containing bag 60 includes a bag main body 62 for containing a liquid and the supply member 64, which includes a liquid supply portion 65. The bag main body 62 has flexibility. The bag main body 62 of the present embodiment is a pillow type bag body formed through stacking of two rectangular films and joining peripheral edges of the films to each other. The bag main body 62 includes one end portion 62a which is an end portion on one side in the longitudinal direction and another end portion 62b which is an end portion on the other side in the longitudinal direction. In another embodiment, the bag main body 62 may be of a gusset type. Each of the films constituting the bag main body 62 is formed of a material having flexibility and gas barrier properties. Examples of the material of the film include polyethylene terephthalate (PET), nylon, and polyethylene. In addition, the film may be formed using a laminated structure in which a plurality of films formed of these materials is laminated. In such a laminated structure, for example, an outer layer may be formed of PET or nylon, which has excellent impact resistance, and an inner layer may be formed of polyethylene, which has excellent ink resistance. Moreover, a film having a layer of aluminum or the like deposited thereon may be used as one constituent member of the laminated structure.

As illustrated in FIG. 6, the supply member 64 is attached to the one end portion 62a side of the bag main body 62. Specifically, a joint portion 64e of the supply member 64 is interposed between the two films constituting the bag main body 62 and is attached to the two films by fusion bonding or the like. The liquid supply portion 65 has a tubular shape extending in the longitudinal direction. As illustrated in FIG. 3, the liquid supply portion 65 has a central axis CT extending in the longitudinal direction. As illustrated in FIG. 7, a base end portion 65e of the liquid supply portion 65 is connected to the joint portion 64e. A leading end portion 65p of the liquid supply portion 65 forms an opening through which a liquid flows out to the outside. In an initial state before use of the liquid container 20, a film FM is attached to the leading end portion 65p so as to close the opening. In a case where the liquid container 20 is used, the film FM is peeled off by the user or is pierced by the liquid introduction portion 32 when the liquid container 20 is mounted into the liquid ejecting apparatus 11.

The liquid supply portion 65 is in communication with an inside of the bag main body 62, and the liquid contained in the bag main body 62 flows therethrough. Specifically, the liquid in the bag main body 62 flows to the liquid supply portion 65 through an internal flow path of the joint portion 64e. The liquid supply portion 65 supplies the liquid contained in the bag main body 62 to the liquid ejecting apparatus 11. As the liquid in the bag main body 62 is consumed via the liquid supply portion 65, the two films are deformed so as to approach each other, and a volume of the bag main body 62 decreases.

As illustrated in FIGS. 6 and 7, the supply member 64 further includes insertion portions 68. The insertion portions 68 include screw insertion holes 67 into which the screw members BN are inserted. The insertion portions 68 have a plate shape. The insertion portions 68 are connected to side walls of the liquid supply portion 65. As illustrated in FIG. 7, in the X direction, which is the lateral direction, the insertion portions 68 include a first insertion portion 68a located on the −X direction side, which is one side of the liquid supply portion 65, and a second insertion portion 68b located on the +X direction side, which is the other side of the liquid supply portion 65. That is, the first insertion portion 68a and the second insertion portion 68b that are integrated with the liquid supply portion 65 are located on both sides in the X direction with the liquid supply portion 65 interposed therebetween. The first insertion portion 68a corresponds to the first screw member BNa. The first insertion portion 68a is used for fixing between members using the first screw member BNa. The second insertion portion 68b corresponds to the second screw member BNb. The second insertion portion 68b is used for fixing between members using the second screw member BNb.

The insertion portions 68 include the screw insertion holes 67 into which the screw members BN are inserted. The screw insertion holes 67 extend through main bodies of the insertion portions 68 in the Z direction, which is the thickness direction. The screw insertion holes 67 include a first screw insertion hole 67a formed in the first insertion portion 68a and a second screw insertion hole 67b formed in the second insertion portion 68b.

As illustrated in FIGS. 3 and 6, the adapter 100 is disposed on the one end portion 62a side of the bag main body 62. The adapter 100 is formed of, for example, a synthetic resin such as polypropylene. As illustrated in FIG. 3, the adapter 100 has a substantially rectangular parallelepiped shape. As illustrated in FIGS. 3 and 4, the adapter 100 includes a first surface 50fa, a second surface 50fb, a third surface 50fc, a fourth surface 50fd, and a fifth surface 50fe.

The first surface 50fa is a leading end surface on the mounting direction side of the liquid container 20 into the liquid ejecting apparatus 11. As illustrated in FIG. 6, the first surface 50fa is mainly formed by the second adapter 50. The second surface 50fb intersects with the first surface 50fa. In the mounted state, the second surface 50fb constitutes an upper surface. As illustrated in FIG. 6, the second surface 50fb is mainly formed by the first adapter 40. As illustrated in FIG. 4, the third surface 50fc is located on a side opposite to the second surface 50fb and intersects with the first surface 50fa. In the mounted state, the third surface 50fc constitutes a bottom surface. As illustrated in FIG. 6, the third surface 50fc is formed by the second adapter 50. As illustrated in FIG. 3, the fourth surface 50fd constitutes a first side surface. The fourth surface 50fd intersects with the first surface 50fa, the second surface 50fb, and the third surface 50fc. As illustrated in FIG. 6, the fourth surface 50fd is formed by the first adapter 40 and the second adapter 50. As illustrated in FIG. 5, the fifth surface 50fe faces the fourth surface 50fd and constitutes a second side surface. The fifth surface 50fe intersects with the first surface 50fa, the second surface 50fb, and the third surface 50fc. As illustrated in FIG. 6, the fifth surface 50fe is formed by the first adapter 40 and the second adapter 50.

As illustrated in FIG. 3, the adapter 100 includes connection elements for connecting to the connection mechanism 29 of the liquid ejecting apparatus 11. The adapter 100 includes, as the connection elements, a supply portion arrangement hole 52, a container-side positioning portion 77, a first guide hole 57, a second guide hole 59, and an identification portion 54. In addition, the liquid container 20 includes a substrate 76 disposed in the adapter 100.

The supply portion arrangement hole 52 is an opening formed in the first surface 50fa. As illustrated in FIG. 6, the supply portion arrangement hole 52 is formed in the second adapter 50. As illustrated in FIG. 5, when viewed from a side in a direction along the central axis CT of the liquid supply portion 65, for example, when viewed from the first surface 50fa side, the supply portion arrangement hole 52 overlaps with the leading end portion 65p of the liquid supply portion 65. In the state where the liquid container 20 is mounted in the liquid ejecting apparatus 11, the liquid introduction portion 32 illustrated in FIG. 2 is inserted into the supply portion arrangement hole 52. The liquid introduction portion 32 inserted into the supply portion arrangement hole 52 is connected to the liquid supply portion 65.

As illustrated in FIG. 3, the container-side positioning portion 77 is formed in a corner portion 71 where the first surface 50fa and the second surface 50fb intersect with each other. The corner portion 71 has a recessed shape. As illustrated in FIG. 5, the corner portion 71 having a recessed shape includes a substrate arrangement wall 71fc constituting a bottom portion of the recessed shape and a pair of side walls 71fa and 71fb rising from the substrate arrangement wall 71fc.

On the substrate arrangement wall 71fc, the substrate 76 is arranged. The substrate arrangement wall 71fc is inclined so as to be located on the third surface 50fc side toward the first surface 50fa side. Container-side electrodes 701 that come into contact with the apparatus-side electrodes 401 are formed on a surface of the substrate 76. On a rear surface of the substrate 76, a memory that stores information related to the liquid container 20, such as an amount of the liquid remaining in the liquid container 20, is disposed. In the mounted state, the memory of the substrate 76 and the control device 42 of the liquid ejecting apparatus 11 exchange information. Nine container-side electrodes 701 are provided corresponding to the number of the apparatus-side electrodes 401. The number of the container-side electrodes 701 is not limited to the above-described number and may be less than nine or more than nine. For example, the number of the container-side electrodes 701 may be five or seven.

The pair of side walls 71fa and 71fb are the first side wall 71fa and the second side wall 71fb. The first side wall 71fa and the second side wall 71fb face each other in the X direction. The first side wall 71fa and the second side wall 71fb each include the container-side positioning portion 77 for positioning the substrate 76 and the apparatus-side electrodes 401. The container-side positioning portion 77 included in the first side wall 71fa is a first container-side positioning portion 77a. The container-side positioning portion 77 included in the second side wall 71fb is a second container-side positioning portion 77b. The first container-side positioning portion 77a is a groove portion formed in the first side wall 71fa. The first container-side positioning portion 77a extends from the first surface 50fa along the central axis CT. The second container-side positioning portion 77b is a groove portion formed in the second side wall 71fb. The second container-side positioning portion 77b extends from the first surface 50fa along the central axis CT. In a process of mounting the liquid container 20 into the liquid ejecting apparatus 11, the first apparatus-side positioning portion 49a, which is a protrusion, is inserted into the first container-side positioning portion 77a, which is a groove portion, and the second apparatus-side positioning portion 49b, which is a protrusion, is inserted into the second container-side positioning portion 77b, which is a groove portion. This configuration restrains movement of the substrate 76 with respect to the apparatus-side electrical connecting portion 41 in a direction orthogonal to the central axis CT, thereby facilitating positioning of the substrate 76 and the apparatus-side electrodes 401.

As illustrated in FIG. 6, the substrate arrangement wall 71fc and the side walls 71fa and 71fb are formed in the arrangement portion 70 of the second adapter 50. That is, the arrangement portion 70 includes the substrate arrangement wall 71fc and the side walls 71fa and 71fb. As described above, the substrate 76, which comes into contact with the apparatus-side electrodes 401 included in the liquid ejecting apparatus 11, is arranged in the arrangement portion 70. In addition, the arrangement portion 70 includes the container-side positioning portion 77.

As illustrated in FIG. 3, the first guide hole 57 and the second guide hole 59 are formed in the first surface 50fa. As illustrated in FIG. 6, the first guide hole 57 and the second guide hole 59 are formed in the adapter main body 51 of the second adapter 50. The first guide hole 57 and the second guide hole 59 are located on both sides with the supply portion arrangement hole 52 interposed therebetween.

In the process of mounting the liquid container 20 into the liquid ejecting apparatus 11, the second positioning portion 46 illustrated in FIG. 2 is inserted into the first guide hole 57. In addition, in the mounting process, the first positioning portion 45 illustrated in FIG. 2 is inserted into the second guide hole 59. Accordingly, in the mounting process, the liquid container 20 is guided in the mounting direction.

As illustrated in FIG. 3, the identification portion 54 is provided in a portion where the first surface 50fa and the second surface 50fb intersect with each other. As illustrated in FIG. 6, the identification portion 54 is formed in the adapter main body 51 of the second adapter 50. The identification portion 54 has protrusions and recesses shaped to be fitted to the block 44 of a corresponding connection mechanism 29. In a case where the liquid container 20 is correctly mounted in the liquid ejecting apparatus 11, the identification portion 54 is appropriately fitted to the block 44 of the connection mechanism 29. On the other hand, when the liquid container 20 is attempted to be mounted at a wrong position, the identification portion 54 is not fitted to the block 44, and therefore, the liquid container 20 cannot advance further to the back, and the erroneous mounting is prevented.

As illustrated in FIG. 3, the liquid container 20 further includes a handle member 30. As illustrated in FIG. 6, the handle member 30 is attached to the first adapter 40 of the adapter 100. The handle member 30 is formed of a member separate from the adapter 100. As illustrated in FIG. 3, the handle member 30 is movable by rotating around a rotation shaft 33 formed by the adapter 100 and the handle member 30. The handle member 30 has a grip portion 31 to be gripped by the user. The grip portion 31 is located on the bag main body 62 side further from the adapter 100 than is the rotation shaft 33. The handle member 30 may be omitted in another embodiment.

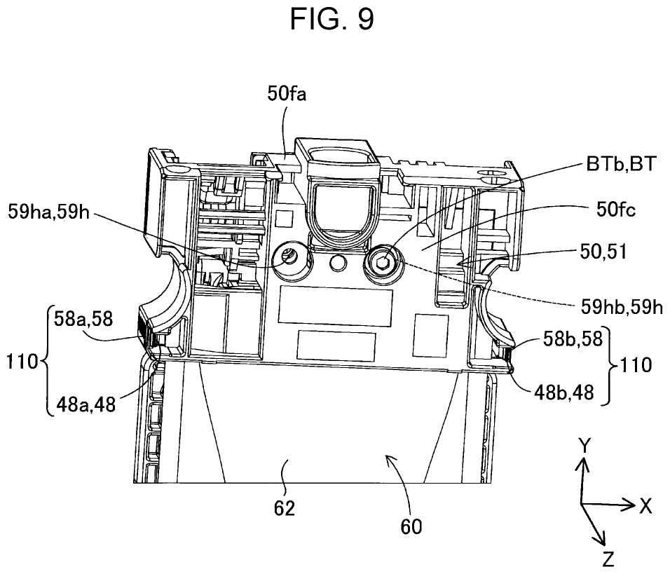

Next, a fixing mechanism of the supply member 64 and the adapter 100 will be described. FIG. 8 is an illustration for explaining a snap-fitting mechanism 110. FIG. 9 is an illustration of the adapter 100 viewed from the third surface 50fc side. In the present embodiment, the supply member 64 and the adapter 100 are fixed to each other by engagement using the screw members BN and the snap-fitting mechanism 110 to be described later. Here, the snap-fitting mechanism 110 fixes the first adapter 40 and the second adapter 50. The supply member 64 is held between the first adapter 40 and the second adapter 50 by the fixing by the snap-fitting mechanism 110. The supply member 64 is fixed to the adapter 100 by being held between the first adapter 40 and the second adapter 50.

First, the snap-fitting mechanism 110 will be described. The first adapter 40 and the second adapter 50 have the snap-fitting mechanism 110. The snap-fitting mechanism 110 fixes members to each other by using elasticity of the members. As illustrated in FIGS. 6 and 9, the snap-fitting mechanism 110 includes elastic engaging portions 48 included in the first adapter 40 and engaged portions 58 included in the adapter main body 51 of the second adapter 50.

The elastic engaging portions 48 have a claw shape that protrudes toward the second adapter 50 from positions on both sides of the first adapter 40 in the lateral direction of the liquid container 20. Two elastic engaging portions 48 are provided. As illustrated in FIG. 9, one of the elastic engaging portions 48 located on the −X direction side in the lateral direction is referred to as a first elastic engaging portion 48a. The other one of the elastic engaging portions 48 located on the +X direction side in the lateral direction is referred to as a second elastic engaging portion 48b. Leading end sides of the first elastic engaging portion 48a and the second elastic engaging portion 48b can be displaced in a protruding direction by elastic deformation.

As illustrated in FIGS. 6 and 9, the engaged portions 58 are formed in portions located on both sides of the adapter main body 51 in the lateral direction of the liquid container 20. The engaged portions 58 have portions with which the claw-shaped elastic engaging portions 48 engage. Two engaged portions 58 are provided corresponding to the number of the elastic engaging portions 48. As illustrated in FIG. 9, one of the engaged portions 58 engaged with the first elastic engaging portion 48a is referred to as a first engaged portion 58a, and the other one engaged with the second elastic engaging portion 48b is referred to as a second engaged portion 58b.

As illustrated in FIG. 8, the elastic engaging portions 48 are inserted into the engaged portions 58, and claw portions 481 on the leading end sides of the elastic engaging portions 48 engage with the engaged portions 58. Accordingly, the first adapter 40 and the second adapter 50 are fixed by the snap-fitting mechanism 110.

Next, fixing between members by the screw members BN will be described. As illustrated in FIG. 9, main body insertion holes 59h are formed in the third surface 50fc of the adapter main body 51. The main body insertion holes 59h extend through the second adapter 50 in the Z direction. The bolts BT of the screw members BN are inserted into the main body insertion holes 59h. Two main body insertion holes 59h are provided corresponding to the number of screw members BN. One of the two main body insertion holes 59h corresponding to the first screw member BNa is referred to as a first main body insertion hole 59ha, and the other one corresponding to the second screw member BNb is referred to as a second main body insertion hole 59hb. For ease of understanding, FIG. 9 illustrates a state where the second bolt BTb is inserted into the second main body insertion hole 59hb, and the first bolt BTa is not inserted into the first main body insertion hole 59ha. As described above, the screw members BN are inserted into the adapter main body 51.

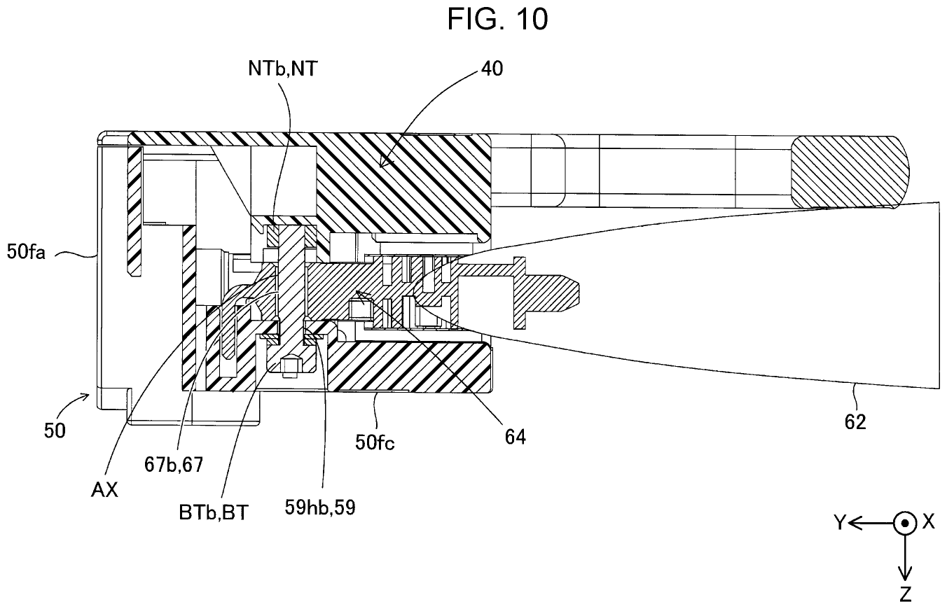

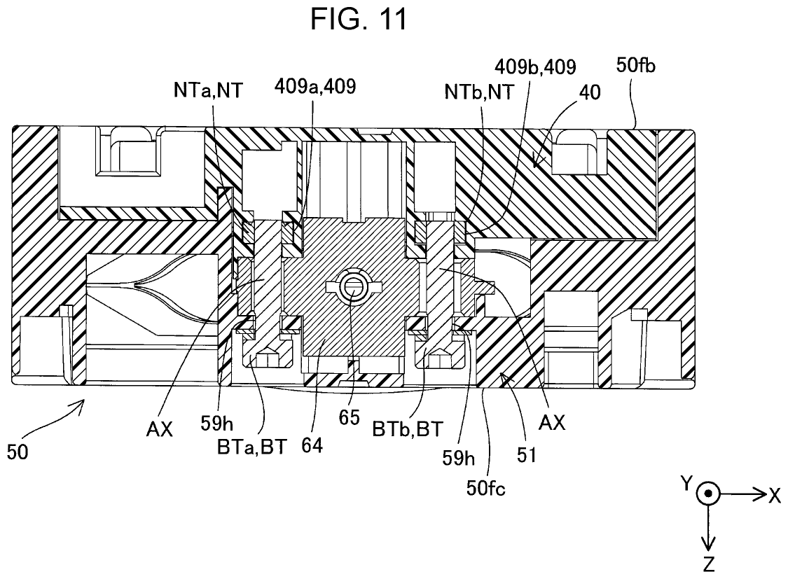

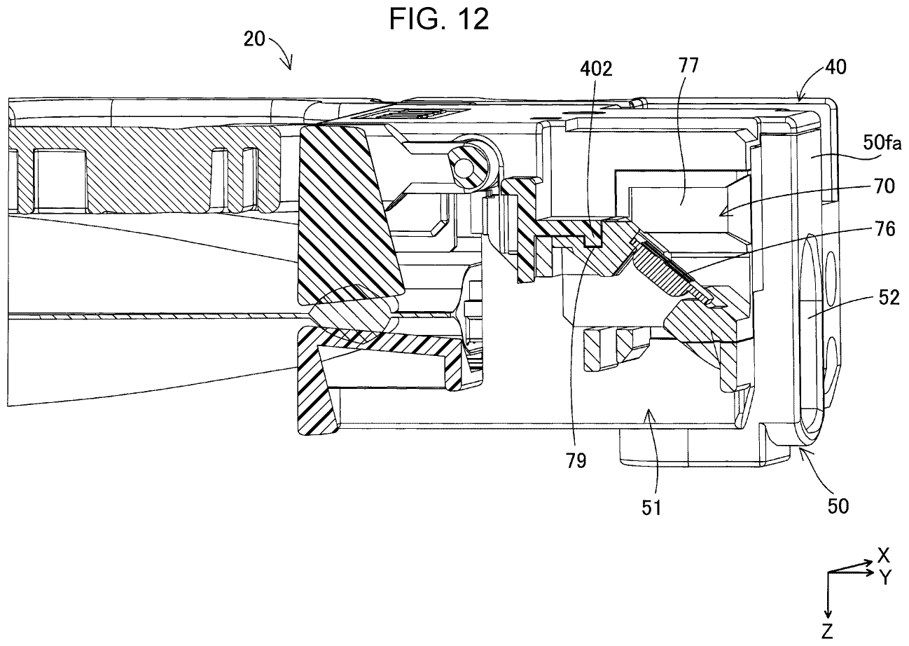

Moreover, fixing between members by the screw members BN will be described with reference to FIGS. 10 and 11. FIG. 10 is a partial sectional view taken along line X-X of FIG. 5. FIG. 11 is a sectional view taken along line XI-XI of FIG. 3.

As illustrated in FIG. 11, the first adapter 40 includes nut arrangement portions 409 that form arrangement spaces in which the nuts NT are arranged. The nut arrangement portions 409 form arrangement spaces corresponding to the outer peripheral shape of the nuts NT. The outer peripheral shape of the nuts NT is a rectangular shape. The nut arrangement portions 409 restrain rotation of the nuts NT around axes of the screw members BN by walls partitioning the arrangement spaces. Two nut arrangement portions 409 are provided corresponding to the number of the screw members BN. One of the two nut arrangement portions 409 corresponding to the first screw member BNa is referred to as a first nut arrangement portion 409a, and the other one corresponding to the second screw member BNb is referred to as a second nut arrangement portion 409b.

The fixing by the bolts BT is performed in a state where the nuts NT are arranged in the nut arrangement portions 409 in advance, and the first adapter 40, and the second adapter 50 are fixed by engagement by the snap-fitting mechanism 110. As illustrated in FIG. 11, shaft portions AX of the bolts BT are inserted into the main body insertion holes 59h, the screw insertion holes 67, and the nuts NT, and the first adapter 40, the second adapter 50, and the supply member 64 are fixed through fastening of the bolts BT in this state.

Due to a fastening force of the screw members BN, the first adapter 40 and the adapter main body 51 of the second adapter 50 are slightly deformed so as to approach each other. At this time, the adapter main body 51 and the supply member 64 have portions that come into contact with each other in the Z direction. In addition, the first adapter 40 and the supply member 64 have portions that come into contact with each other in the Z direction. Accordingly, since it is possible to suppress deformation of the first adapter 40 and the adapter main body 51 of the second adapter 50 due to the fastening force, it is possible to suppress a positional deviation of the liquid supply portion 65 with respect to the adapter 100. In addition, as illustrated in FIG. 11, since the screw members BN are located on both sides with the liquid supply portion 65 interposed therebetween, it is possible to further suppress the positional deviation of the liquid supply portion 65 with respect to the adapter 100 compared to a case where a screw member BN is located on only one side with respect to the liquid supply portion 65.

FIG. 12 is an illustration for explaining fixing between the arrangement portion 70 in which the substrate 76 is arranged and the adapter main body 51. As illustrated in FIG. 6, the adapter main body 51 includes a main body arrangement portion 56 in which the arrangement portion 70 is arranged. The main body arrangement portion 56 is formed on a side opposite to the identification portion 54 with the supply portion arrangement hole 52 interposed therebetween. The main body arrangement portion 56 has a recessed shape for accommodating the arrangement portion 70. For example, the arrangement portion 70 is moved in the −Y direction and accommodated and arranged in the main body arrangement portion 56. In a state where the arrangement portion 70 is arranged in the main body arrangement portion 56, the first adapter 40 and the second adapter 50 are fixed by the snap-fitting mechanism 110 and each screw member BN.

As illustrated in FIG. 12, the arrangement portion 70 includes a member engaged portion 79 on a wall facing the first adapter 40. The member engaged portion 79 has a groove shape extending in the X direction in which the first side wall 71fa and the second side wall 71fb face each other. The groove-shaped member engaged portion 79 is open on a side where the first adapter 40 is located. The first adapter 40 of the adapter 100 includes an arrangement portion-engaging portion 402. The arrangement portion-engaging portion 402 has a protrusion shape protruding toward the second adapter 50 side. The arrangement portion-engaging portion 402 engages with the member engaged portion 79 by entering the member engaged portion 79. This engagement restrains movement of the arrangement portion 70 in the Y direction. That is, the arrangement portion-engaging portion 402 fixes the arrangement portion 70 by engaging with the member engaged portion 79 of the arrangement portion 70.

According to the above-described embodiment, as illustrated in FIGS. 6, 10, and 11, since the supply member 64 and the adapter 100 are fixed to each other by the screw members BN, it is possible to reduce occurrence of a problem such as unintentional release of the fixing between the supply member 64 and the adapter 100. In addition, since the fixing by the screw members BN can be released using a tool such as a general driver, the supply member 64, the first adapter 40, and the second adapter 50 can be easily disassembled. Accordingly, members constituting the liquid container 20 can be reused, and the environmental load can be reduced. For example, it is possible to easily disassemble the supply member 64, the first adapter 40, and the second adapter 50 through releasing of the fixing by the screw members BN and the engagement by the snap-fitting mechanism 110 after the liquid of the liquid container 20 is completely consumed. As a result, for example, the first adapter 40 and the second adapter 50 can be reused.

In addition, as illustrated in FIG. 6, the arrangement portion 70 can be removed from the adapter main body 51. When the liquid container 20 is repeatedly attached to and removed from the liquid ejecting apparatus 11, the number of times the substrate 76 arranged in the arrangement portion 70 rubs against the apparatus-side electrical connecting portion 41 increases, and the substrate 76 tends to wear. In addition, the memory included in the substrate 76 has an upper limit of a lifetime or a storage capacity. Therefore, when it is necessary to discard the substrate 76, it is possible to discard only the arrangement portion 70 and reuse the adapter main body 51 through removing of the arrangement portion 70 from the adapter main body 51. In addition, in the liquid container 20, in a case where the substrate 76 is damaged or reaches the end of its life, it is possible to continue the use of the liquid container 20 through replacing of only the arrangement portion 70. In addition, through forming of the arrangement portion 70 as a separate member from the adapter main body 51, the arrangement portion 70 can be used as a component of another type of liquid container. That is, the arrangement portion 70 can be manufactured as a common component for various liquid containers.

In addition, according to the above-described embodiment, as illustrated in FIGS. 6, 10, and 11, the screw members BN are inserted into the screw insertion holes 67 of the supply member 64 including the liquid supply portion 65, and thus it is possible to directly fix the adapter 100 and the supply member 64 to each other using the screw members BN. Accordingly, it is possible to suppress the positional deviation of the supply member 64 including the liquid supply portion 65 with respect to the adapter 100. According to the above-described embodiment, as illustrated in FIG. 11, the supply member 64 can be fixed to the adapter 100 using the first screw member BNa and the second screw member BNb on both sides with the liquid supply portion 65 interposed therebetween. Accordingly, it is possible to further suppress a positional deviation of the liquid supply portion 65 with respect to the adapter 100.

In addition, according to the above-described embodiment, as illustrated in FIG. 12, it is possible to easily fix a position of the arrangement portion 70 through restraining of the movement of the arrangement portion 70 in the Y direction using the arrangement portion-engaging portion 402. In addition, the arrangement portion 70 is interposed between the first adapter 40 and the adapter main body 51. In the adapter main body 51 and the first adapter 40, it is possible to easily remove the arrangement portion 70 from the adapter main body 51 through disassembling the adapter main body 51 and the first adapter 40 through releasing of the fixing by the screw members BN and the engagement by the snap-fitting mechanism 110.

In addition, according to the above-described embodiment, the first adapter 40 and the second adapter 50 have the snap-fitting mechanism 110 that fixes the first adapter 40 and the second adapter 50 to each other by using the elasticity of the members. Accordingly, in a process of assembling the liquid container 20, it is possible to suppress separation of the first adapter 40 from the second adapter 50 before fixing by the screw members BN. Therefore, assembly efficiency of the liquid container 20 can be improved.

### B. Other Embodiments

### B1. Other Embodiment 1

In the above-described embodiment, as illustrated in FIG. 6, the screw members BN are constituted by the bolts

BT and the nuts NT, but the present disclosure is not limited thereto. For example, the screw members BN may be tapping screws.

### B2. Other Embodiment 2

In the above-described embodiment, the liquid container 20 has the snap-fitting mechanism 110, but the snap-fitting mechanism 110 may be omitted.

### B3. Other Embodiment 3

In the above-described embodiment, as illustrated in FIG. 6, the adapter 100 includes the first adapter 40 and the second adapter 50, but may include only the second adapter 50. In this case, the second adapter 50 and the supply member 64 are fixed by the screw members BN. In addition, in this case, the second adapter 50 and the supply member 64 may have a snap-fitting mechanism that fixes the second adapter 50 and the supply member 64 to each other by using the elasticity of the members. For example, the supply member 64 may include the elastic engaging portions 48 included in the first adapter 40. By doing so, in the process of assembling the liquid container 20, it is possible to suppress separation of the adapter 100 from the supply member 64 before fixing by the screw members BN.

Accordingly, the assembly efficiency of the liquid container 20 can be improved.

### C. Other Aspects

The present disclosure is not limited to the above-described embodiments and can be implemented in various aspects without departing from the spirit thereof. For example, the present disclosure can also be implemented in the following aspects. The technical features in the above-described embodiments corresponding to the technical features in each aspect described below can be appropriately replaced or combined in order to solve some or all of the problems to be solved by the present disclosure or in order to achieve some or all of the effects of the present disclosure. In addition, if the technical features are not described as essential in this specification, the technical features can be appropriately deleted.
(1) According to an aspect of the present disclosure, there is provided a liquid container that supplies a liquid to a liquid ejecting apparatus. The liquid container includes a liquid containing bag including a bag main body for containing the liquid and a supply member that is attached to one end portion side of the bag main body and that includes a liquid supply portion, an adapter disposed on the one end portion side of the bag main body, and a screw member that fixes the supply member and the adapter. According to this aspect, it is possible to reduce occurrence of a problem such as unintentional release of fixing between the supply member and the adapter in which the supply member and the adapter are fixed by the screw member. In addition, since the supply member and the adapter can be disassembled, for example, the adapter can be reused.
(2) In the above-described aspect, the supply member may include an insertion portion that includes a screw insertion hole into which the screw member is inserted and that is connected to the liquid supply portion, and the screw member may be inserted into the screw insertion hole. According to this aspect, since the screw member is inserted into the screw insertion hole of the supply member including the liquid supply portion, it is possible to directly fix the adapter and the supply member to each other using the screw member. Accordingly, it is possible to suppress a positional deviation of the supply member including the liquid supply portion with respect to the adapter.
(3) In the above-described aspect, the screw member may include a first screw member and a second screw member, the insertion portion may include a first insertion portion corresponding to the first screw member and a second insertion portion corresponding to the second screw member, and the first insertion portion and the second insertion portion may be located with the liquid supply portion interposed therebetween. According to this aspect, the supply member can be fixed to the adapter using the first screw member and the second screw member on both sides with the liquid supply portion interposed therebetween. Accordingly, it is possible to further suppress a positional deviation of the liquid supply portion with respect to the adapter.
(4) In the above-described aspect, the adapter may include an adapter main body into which the screw member is inserted, and an arrangement portion in which a substrate is arranged, the substrate coming into contact with an apparatus-side electrode included in the liquid ejecting apparatus, and the arrangement portion may be fixed to the adapter main body such that the arrangement portion is removable from the adapter main body. According to this aspect, since the arrangement portion can be removed from the adapter main body, for example, the arrangement portion can be discarded, and the adapter main body can be reused.
(5) In the above-described aspect, the arrangement portion may include a container-side positioning portion that performs positioning of the substrate and the apparatus-side electrode. According to this aspect, it is possible to easily perform positioning of the substrate and the apparatus-side electrode by the container-side positioning portion.
(6) In the above-described aspect, the arrangement portion may include a substrate arrangement wall on which the substrate is arranged and a side wall rising from the substrate arrangement wall, and the container-side positioning portion may be a groove portion that is formed in the side wall and into which an apparatus-side positioning portion included in the liquid ejecting apparatus is inserted. According to this aspect, it is possible to easily perform positioning of the substrate and the apparatus-side electrode using the groove portion.
(7) In the above-described aspect, the adapter may include an arrangement portion-engaging portion that fixes the arrangement portion by engaging with the arrangement portion. According to this aspect, a position of the arrangement portion can be easily fixed by the arrangement portion-engaging portion.
(8) In the above-described aspect, the adapter may include a first adapter and a second adapter located on a side opposite to the first adapter with the supply member interposed therebetween, and the first adapter and the second adapter may have a snap-fitting mechanism that fixes the first adapter and the second adapter to each other by using elasticity of a member. According to this aspect, in a process of assembling the liquid container, it is possible to suppress separation of the first adapter from the second adapter before fixing by the screw member. Accordingly, the assembly efficiency of the liquid container can be improved.
(9) In the above-described aspect, the adapter and the supply member may have a snap-fitting mechanism that fixes the adapter and the supply member to each other by using elasticity of a member. According to this aspect, in the process of assembling the liquid container, it is possible to suppress separation of the adapter from the supply member before fixing by the screw member. Accordingly, the assembly efficiency of the liquid container can be improved.

The present disclosure can be implemented in various aspects other than the above. For example, the disclosure can be implemented in aspects such as a method for manufacturing a liquid container and a liquid ejecting system including a liquid container and a liquid ejecting apparatus.

What is claimed is:

1. A liquid container that supplies a liquid to a liquid ejecting apparatus, the liquid container comprising:
a liquid containing bag including a bag main body for containing the liquid and a supply member that is attached to one end portion side of the bag main body and that includes a liquid supply portion;
an adapter disposed on the one end portion side of the bag main body; and
a screw member that fixes the supply member and the adapter.

2. The liquid container according to claim 1, wherein
the supply member includes an insertion portion that includes a screw insertion hole into which the screw member is inserted and that is connected to the liquid supply portion, and
the screw member is inserted into the screw insertion hole.

3. The liquid container according to claim 2, wherein
the screw member includes a first screw member and a second screw member,
the insertion portion includes a first insertion portion corresponding to the first screw member and a second insertion portion corresponding to the second screw member, and
the first insertion portion and the second insertion portion are located with the liquid supply portion interposed therebetween.

4. The liquid container according to claim 1, wherein
the adapter includes
an adapter main body into which the screw member is inserted, and
an arrangement portion in which a substrate is arranged, the substrate coming into contact with an apparatus-side electrode included in the liquid ejecting apparatus, and
the arrangement portion is fixed to the adapter main body such that the arrangement portion is removable from the adapter main body.

5. The liquid container according to claim 4, wherein
the arrangement portion includes a container-side positioning portion that performs positioning of the substrate and the apparatus-side electrode.

6. The liquid container according to claim 5, wherein
the arrangement portion includes a substrate arrangement wall on which the substrate is arranged and a side wall rising from the substrate arrangement wall, and
the container-side positioning portion is a groove portion that is formed in the side wall and into which an apparatus-side positioning portion included in the liquid ejecting apparatus is inserted.

7. The liquid container according to claim 4, wherein
the adapter includes an arrangement portion-engaging portion that fixes the arrangement portion by engaging with the arrangement portion.

8. The liquid container according to claim 1, wherein
the adapter includes
a first adapter and
a second adapter located on a side opposite to the first adapter with the supply member interposed therebetween, and
the first adapter and the second adapter have a snap-fitting mechanism that fixes the first adapter and the second adapter to each other by using elasticity of a member.

9. The liquid container according to claim 1, wherein
the adapter and the supply member have a snap-fitting mechanism that fixes the adapter and the supply member to each other by using elasticity of a member.
